(19) United States
(12) Patent Application Publication
(10) Pub. No.: US 2026/0288323 A1
(43) Pub. Date: Sep. 24, 2026

(54) FUNCTIONAL OPERATION SYSTEM AND FUNCTIONAL OPERATION METHOD THEREOF

(71) Applicant: COMPAL ELECTRONICS, INC., Taipei City (TW)

(72) Inventor: Jung-Ming Hung, Taipei City (TW)

(73) Assignee: COMPAL ELECTRONICS, INC., Taipei City (TW)

(21) Appl. No.: 19/561,572

(22) Filed: Mar. 10, 2026

Related U.S. Application Data
(60) Provisional application No. 63/776,250, filed on Mar. 23, 2025.

(51) Int. Cl. G06F 3/04847; G06F 3/042; G06F 3/0488; G06T 7/20; G06T 7/50; G09G 3/00

(52) U.S. Cl. CPC G06F 3/04847; G06F 3/0425; G06F 3/0488; G06T 7/20; G06T 7/50; G09G 3/002; G06F 2203/04101; G06T 2207/10028; G06T 2207/30196; G06T 2207/30241

(57) ABSTRACT

A functional operation system and a functional operation method thereof are provided. In the method, a depth of an operating object in a depth image is detected, and a depth value corresponding to a depth axis is generated. A target function is selected according to the depth value. A movement trajectory of the operating object on an operating axis is detected, and a corresponding operating value is generated, where the operating axis is perpendicular to the depth axis. A function value of the target function is adjusted according to the operating value.

### CROSS-REFERENCE TO RELATED APPLICATION

This application claims the priority benefit of U.S. provisional application serial no. 63/776,250, filed on Mar. 23, 2025. The entirety of the above-mentioned patent application is hereby incorporated by reference herein and made a part of this specification.

### BACKGROUND

### Technical Field

The disclosure relates to a human-machine interaction technology, and particularly relates to a functional operation system and a functional operation method thereof.

### Description of Related Art

In recent years, interactive projection technology has developed rapidly, and some projector products may already perform interactive operations based on user gestures. Such operations mostly simulate traditional two-dimensional plane operations, e.g., moving a cursor, clicking an icon, or dragging an object.

However, the two-dimensional plane operation method has problems of inconvenient operation when applied to a projection environment. For example, when a user needs to adjust system functions (such as system volume, screen brightness, mouse sensitivity) or execute shortcut keys (such as copy, paste), it is often necessary for the user to interrupt the current operation and search for the corresponding control element (e.g., a slider or a button) in the user interface on the two-dimensional plane. Such an operation process is not only cumbersome, but also has an obvious operation gap compared with the intuitiveness of using physical shortcut keys.

### SUMMARY

The disclosure provides a functional operation system and a functional operation method thereof, which may provide more convenient, fast, and intuitive operation.

A functional operation method of the embodiment of the disclosure is implemented by a processor. The functional operation method includes (but is not limited to) following steps. A depth of an operating object in a depth image is detected, and a depth value corresponding to a depth axis is generated. A target function is selected according to the depth value. A movement trajectory of the operating object on an operating axis is detected, and a corresponding operating value is generated, where the operating axis is perpendicular to the depth axis. A function value of the target function is adjusted according to the operating value.

A functional operation system of the embodiment of the disclosure includes (but is not limited to) a depth sensor and a processor. The depth sensor is configured to generate a depth image, wherein the depth image includes an operating object. The processor is communicatively connected to the depth sensor and configured to perform following operations: detecting a depth of an operating object in a depth image, and generating a depth value corresponding to a depth axis; selecting a target function according to the depth value; detecting a movement trajectory of the operating object on an operating axis, and generating a corresponding operating value, where the operating axis is perpendicular to the depth axis; and adjusting a function value of the target function according to the operating value.

Based on the above, the functional operation system and the functional operation method thereof of the embodiment of the disclosure use depth (e.g., a first axis) to detect a depth value of an operating object so as to select a corresponding target function (e.g., volume, brightness), and then detect movement of the operating object on an operating axis (e.g., a second axis) perpendicular to the depth so as to adjust a function value of the target function (e.g., loudness, or brightness). Accordingly, the disclosure provides an intuitive two-dimensional control method, allowing a user to quickly adjust system functions without interrupting the current operation or searching for user interface elements, significantly improving the convenience and intuitiveness of operation.

In order to make the above-mentioned features and advantages of the disclosure clearer and easier to understand, the following embodiments are given and described in details with accompanying drawings as follows.

### BRIEF DESCRIPTION OF THE DRAWINGS

FIG. 1 is a block diagram of elements of a functional operation system according to an embodiment of the disclosure.

FIG. 2A is a schematic diagram of a usage scenario according to an embodiment of the disclosure.

FIGS. 2B and 2C are schematic diagrams of an operating object and two axes according to an embodiment of the disclosure.

FIG. 3 is a flowchart of a functional operation method according to an embodiment of the disclosure.

FIG. 4 is a flowchart of target function selection according to an embodiment of the disclosure.

FIGS. 5A and 5B are schematic diagrams of depth intervals according to an embodiment of the disclosure.

FIG. 6 is a flowchart of a functional operation method according to an embodiment of the disclosure.

FIG. 7A is a schematic diagram of detecting an operating object according to an embodiment of the disclosure.

FIG. 7B is a schematic diagram of a functional operation cursor according to an embodiment of the disclosure.

FIG. 8 is a flowchart of a projection image generation method according to an embodiment of the disclosure.

FIGS. 9A to 9E are schematic diagrams of a functional operation interface according to an embodiment of the disclosure.

FIG. 10 is a flowchart of a mode apply function according to an embodiment of the disclosure.

### DESCRIPTION OF THE EMBODIMENTS

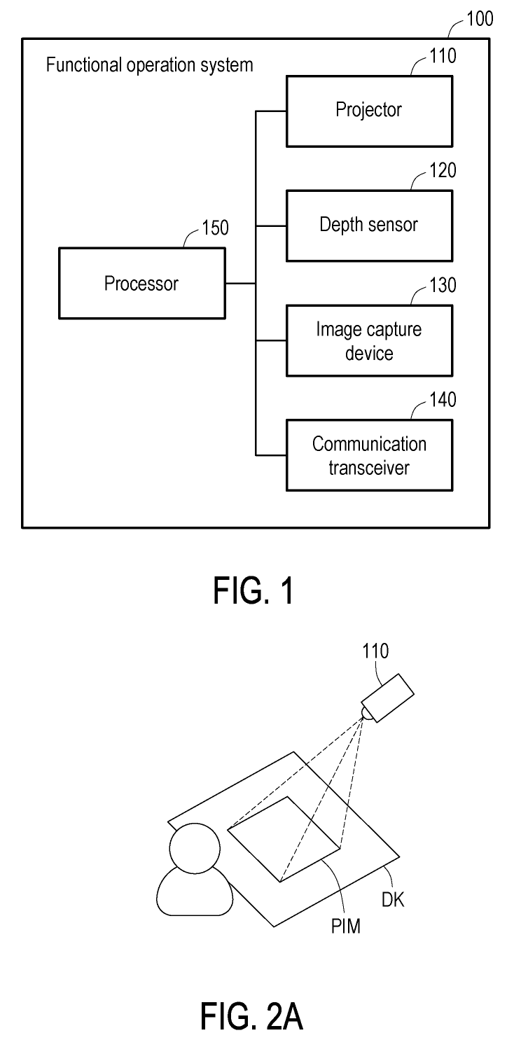

FIG. 1 is a block diagram of elements of a functional operation system 100 according to an embodiment of the disclosure. The functional operation system 100 may be applied to, for example, a smartphone, a tablet computer, a personal computer, a game console, or integrated into a head-mounted device (such as VR/AR glasses). The functional operation system 100 includes (but is not limited to) a projector 110, a depth sensor 120, an image capture device 130, a communication transceiver 140, and a processor 150.

The projector 110 is, for example, a liquid crystal projector, a digital light processing (DLP) projector, or a laser projector. In an embodiment, the projector 110 is configured to receive a projection image (e.g., a function interface and/or visual feedback thereon) generated and output by the processor 150, and project the projection image onto a display area (e.g., a desktop or a wall surface) for the user to view and interact with.

The depth sensor 120 is, for example, a structured light camera, a time-of-flight (ToF) camera, or a stereo vision camera. In an embodiment, the depth sensor 120 is configured to detect a three-dimensional space in front of the functional operation system 100 (e.g., near the projection range of the projector 110), and capture depth information of objects in the environment (particularly an operating object for the operation of the functional operation system 100, such as a hand or a controller) so as to generate a depth image. The processor 150 may then analyze the depth image to obtain spatial coordinates of the operating object.

It is worth noting that depth information refers to distance data (e.g., a distance value or a depth value) describing the distance of a point on the surface of an object relative to the depth sensor 120 or a reference plane. The depth information on each pixel of the depth sensor 120 may be used to generate a depth image. That is to say, each pixel in the depth image corresponds to the depth information reflected from an object in the environment. The processor 150 may then analyze the depth image to obtain three-dimensional spatial coordinates (e.g., X, Y, Z values) of a specific point on the operating object, where for example, the Z value may correspond to its depth or distance relative to the depth sensor 120.

The image capture device 130 is, for example, a complementary metal-oxide-semiconductor (CMOS) or a charge-coupled device (CCD) camera. In an embodiment, the image capture device 130 is configured to capture visible light images (e.g., RGB images) in the environment. These images may be used for subsequently recognizing gestures, types, or contours of the operating object to assist depth detection or perform other operation decisions. In some embodiments, the depth sensor 120 and the image capture device 130 may be integrated into a single module or an independent device (e.g., a camera with RGB-D function).

The communication transceiver 140 is, for example, a transceiver circuit for Wi-Fi, Bluetooth, or mobile communications (e.g., 4G or 5G). In an embodiment, the communication transceiver 140 is configured to exchange data with an external device or a network. For example, the communication transceiver 140 downloads a parameter set of the mode apply function or updates software.

The processor 150 is coupled to the projector 110, the depth sensor 120, the image capture device 130, and the communication transceiver 140. The processor 150 may be a central processing unit (CPU), a graphics processing unit (GPU), an artificial intelligence (AI) accelerator, an application-specific integrated circuit (ASIC), or a combination thereof. In an embodiment, the processor 150 is configured to load and execute program codes and software modules stored in a memory (not shown) to implement the method of the embodiments of the disclosure, which will be described in detail later.

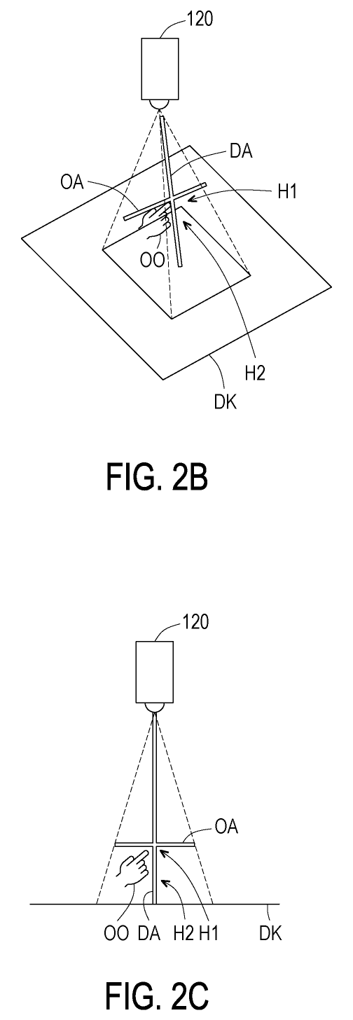

FIG. 2A is a schematic diagram of a usage scenario according to an embodiment of the disclosure. Referring to FIG. 2A, the functional operation system 100 (e.g., a device including the projector 110 and the depth sensor 120) is disposed in an environment. The projector 110 projects a projection image PIM onto a display area DK (e.g., a desktop or a wall surface).

FIGS. 2B and 2C are schematic diagrams of an operating object OO and two axes according to an embodiment of the disclosure. Referring to FIGS. 2B and 2C, the depth sensor 120 detects an operating object OO (a hand is taken as an example, but the operating object may also be a finger or other handheld pointing object) in the space in front of the display area DK. The spatial position and depth of the operating object OO may be detected by the depth sensor 120. For example, the depth sensor 120 detects that the operating object OO is located at a depth H1. The operating object OO may instead be closer to the display area DK and located at a depth H2.

In an embodiment, the processor 150 may define two mutually perpendicular axes. A depth axis DA refers to a depth variation direction (e.g., Z-axis) of the operating object OO relative to the depth sensor 120. As shown in FIG. 2C, the operating object OO may move along the depth axis DA between the depth H1 and the depth H2. An operating axis OA refers to a moving direction perpendicular to the depth axis DA. In some embodiments, the operating axis OA may be used to adjust a parameter of a function or change a function. As shown in FIGS. 2B and 2C, the operating axis OA corresponds to, for example, a horizontal axis (e.g., X-axis) on the projection image PIM, and the operating object OO may move horizontally along the operating axis OA.

Hereinafter, the method described in the embodiments of the disclosure will be described with reference to the devices, components, and/or modules in FIGS. 1 and 2A to 2C. Each process in the method may be adjusted according to implementation circumstances.

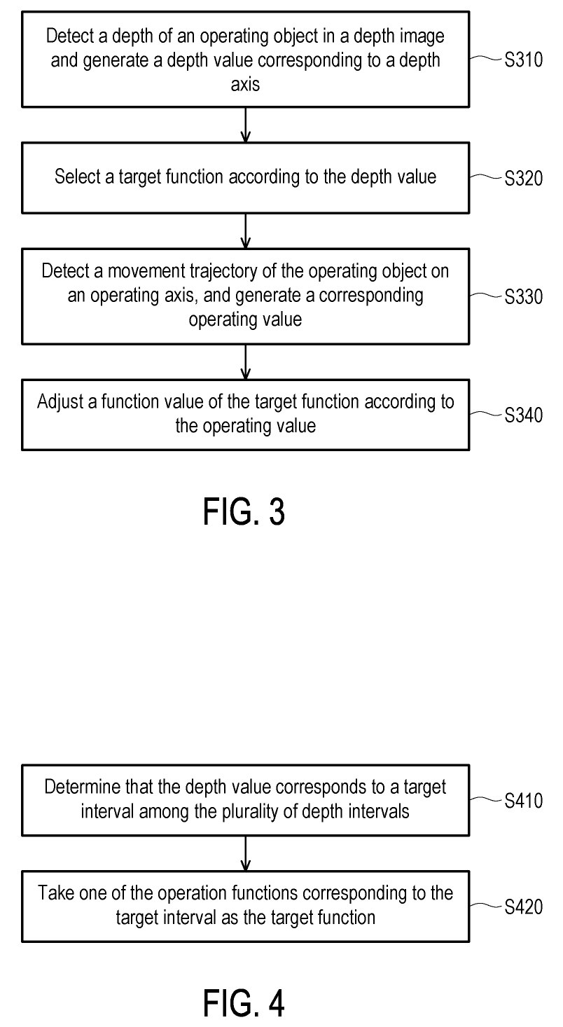

FIG. 3 is a flowchart of a functional operation method according to an embodiment of the disclosure. This method is implemented by the processor 150 of the functional operation system 100. Referring to FIG. 3, the processor 150 detects a depth of an operating object in a depth image, and generates a depth value corresponding to a depth axis (step S310). Specifically, the processor 150 obtains the depth image from the depth sensor 120. As described above, the depth image includes depth information. That is, each pixel in the depth image corresponds to depth information (e.g., a depth value or a distance value) reflected from an object. The processor 150 analyzes the depth image to identify the operating object OO (as shown in FIG. 2B), locates a position of the operating object OO along the depth axis DA, and generates a depth value accordingly. As shown in FIG. 2C, when the operating object OO is located at the depth H1, the processor 150 generates a first depth value (e.g., 60 centimeters); when the operating object OO is located at the depth H2, the processor 150 generates a second depth value (e.g., 80 centimeters).

The processor 150 selects a target function according to the depth value (step S320). Specifically, the target function is a function item that may be adjusted by the user in the functional operation system 100. That is, different depth values may correspond to different operation functions.

FIG. 4 is a flowchart of target function selection according to an embodiment of the disclosure. Referring to FIG. 4, the processor 150 may determine that the depth value corresponds to a target interval among the plurality of depth intervals (step S410). Depth intervals may refer to a plurality of non-overlapping or partially overlapping sections formed by the processor 150 by dividing the detectable range of the depth axis DA (as shown in FIG. 2B). The processor 150 may assign a specific operation function to each depth interval.

When the processor 150 determines that the depth value of the operating object OO falls into a certain depth section, the processor 150 selects this depth section as the target interval. The processor 150 may take one of the operation functions corresponding to the target interval as the target function (step S420). Each operation function is a system function that is pre-defined and mapped to a certain depth interval respectively. The processor 150 may record a mapping table so that each depth interval has a corresponding operation function. The operation function may be a brightness adjustment function, a volume adjustment function, a cursor sensitivity adjustment function, a shortcut key function, and/or a mode apply function.

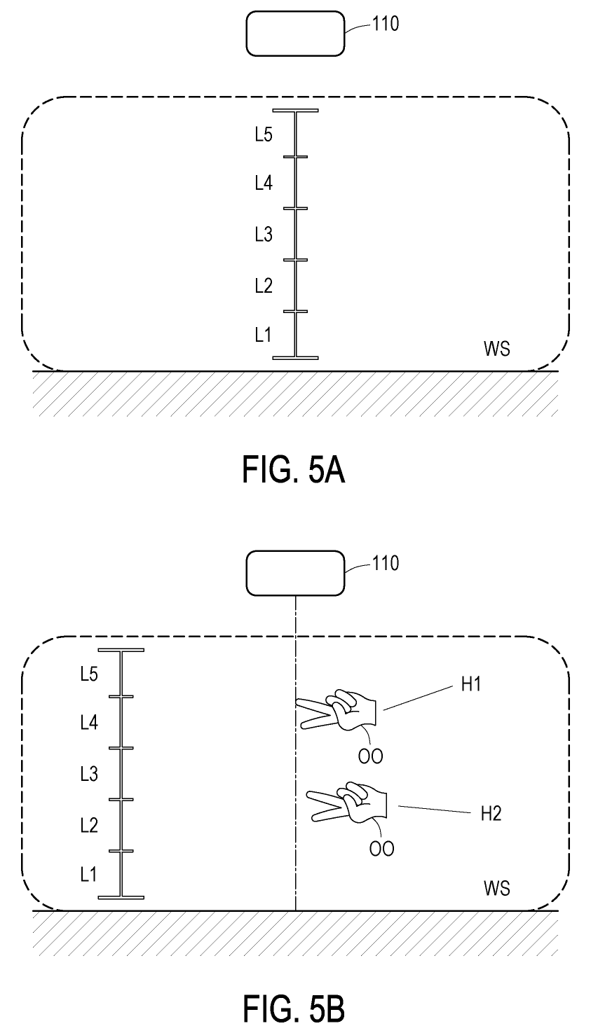

For example, FIGS. 5A and 5B are schematic diagrams of depth intervals according to an embodiment of the disclosure. Referring first to FIG. 5A, the processor 150 divides a workspace WS into a plurality of depth intervals L1, L2, L3, L4, and L5. These depth intervals L1, L2, L3, L4, and L5 correspond to different operation functions respectively. For example, the depth interval L5 corresponds to an operation function T5 (e.g., a brightness adjustment function); the depth interval L4 corresponds to an operation function T4 (e.g., a volume adjustment function); the depth interval L3 corresponds to an operation function T3 (e.g., a shortcut key function); the depth interval L2 corresponds to an operation function T2 (e.g., a cursor sensitivity adjustment function); and the depth interval L1 corresponds to an operation function T1 (e.g., a mode apply function). However, the number of operation functions and the range of corresponding depth intervals may still be adjusted according to actual requirements.

Referring to FIG. 5B, when the processor 150 detects that the depth value of the operating object OO is at the depth H1 (i.e., falls into the depth interval L4), the processor 150 takes the operation function T4 as the target function. Similarly, when the operating object OO moves to the depth H2 (i.e., falls into the depth interval L2), the processor 150 selects the operation function T2 as the target function.

The processor 150 detects a movement trajectory of the operating object on an operating axis, and generates a corresponding operating value (step S330). Specifically, as shown in FIGS. 2B and 2C , when the operating object OO remains at a specific depth (e.g., H1), the processor 150 continuously detects the movement trajectory (e.g., a displacement to the left or to the right) of the operating object OO along the operating axis OA (e.g., a horizontal axis). The operating value is a value generated according to the movement trajectory. The operating value is, for example, a horizontal displacement, a movement speed, or a movement direction.

The processor 150 adjusts a function value of the target function according to the operating value (step S340). Specifically, the function value is a parameter corresponding to the target function. The processor 150 may map the operating value (e.g., a horizontal displacement) to an adjustment of the function value. For example, if the target function is a volume adjustment function, the function value is the level of the volume; if the operating object moves to the right, the processor 150 increases the volume; if the operating object moves to the left, the processor 150 decreases the volume. If the target function is a brightness adjustment function, the function value is the level of the brightness. If the target function is a cursor sensitivity adjustment function, the function value is the dots per inch (DPI) level. However, the type of operation function and its corresponding function value may still be changed according to actual requirements.

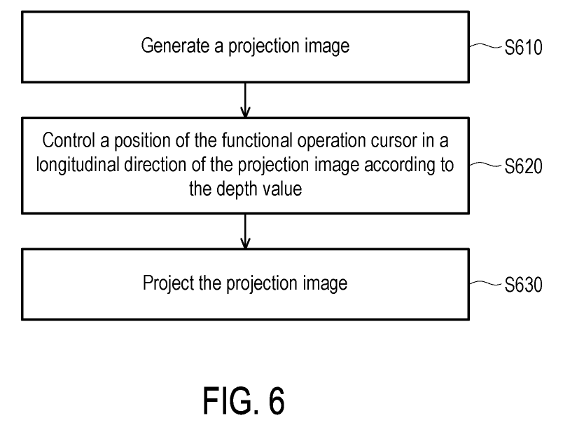

FIG. 6 is a flowchart of a functional operation method according to an embodiment of the disclosure. Referring to FIG. 6, the processor 150 may generate a projection image (step S610). Specifically, the projection image (such as the projection image PIM in FIG. 2A) may present a user interface for providing visual feedback.

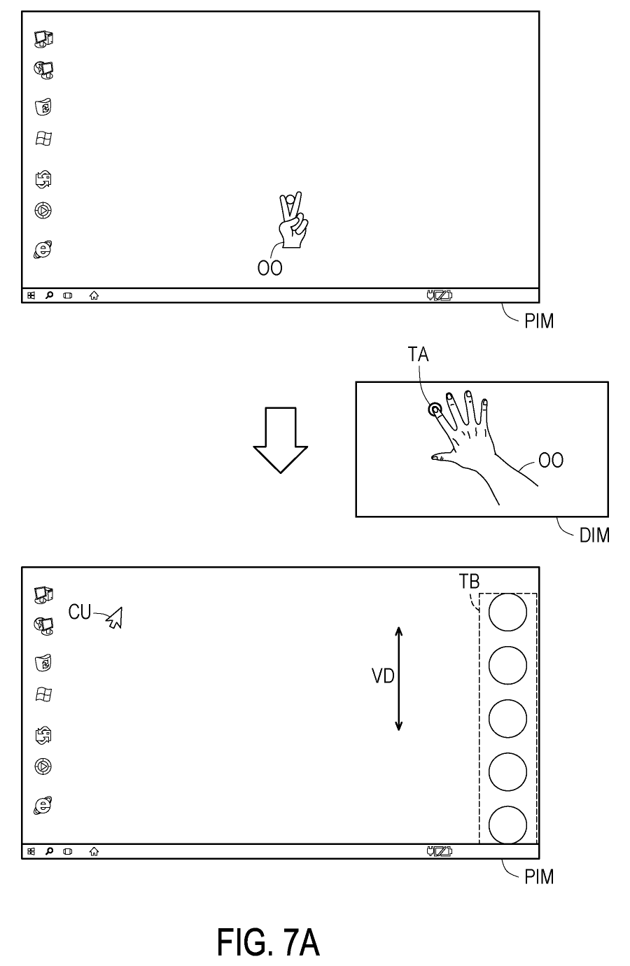

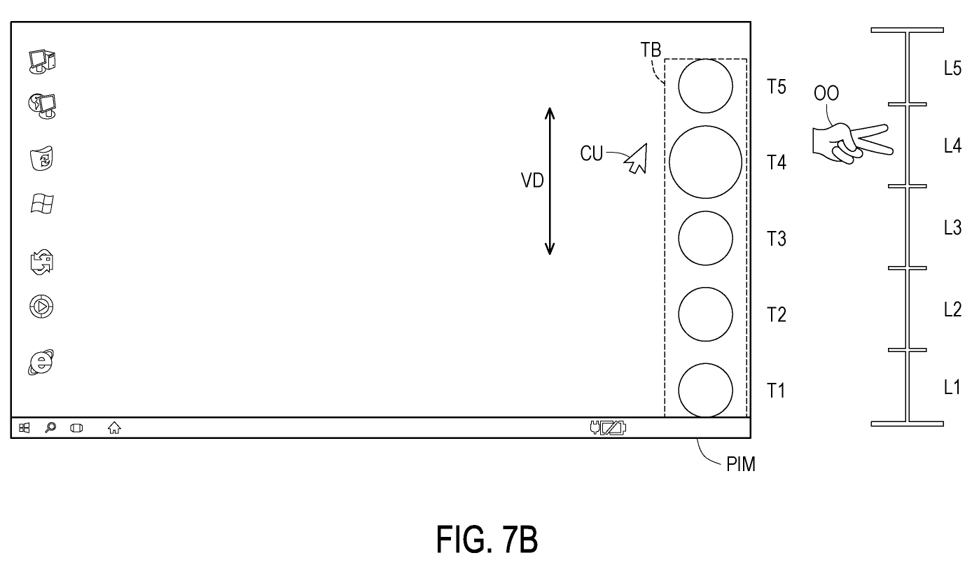

For example, FIG. 7A is a schematic diagram of detecting the operating object OO according to an embodiment of the disclosure. Referring to FIG. 7A, the processor 150 obtains a depth image DIM from the depth sensor 120, and identifies the operating object OO (e.g., a finger of the user) in the depth image DIM. The depth image DIM has an operating area TA, and the operating area TA corresponds to one or more depth values. The processor 150 may execute an artificial intelligence analysis module (e.g., load an artificial intelligence model for gesture recognition), and determine that the operating object OO conforms to a target gesture (e.g., the extension of the index finger and/or the middle finger). Then, the processor 150 may detect a depth change (i.e., different depth values) of the operating area TA.

FIG. 7B is a schematic diagram of a functional operation cursor CU according to an embodiment of the disclosure. Referring to FIGS. 7A and 7B, the projection image PIM may include a functional operation cursor CU and a function toolbar TB. The function toolbar TB includes, for example, depth interval indicators or function indicators (e.g., circular icons in the figure) respectively corresponding to a plurality of operation functions T1-T5.

Referring to FIG. 6, the processor 150 may control a position of the functional operation cursor in a longitudinal direction of the projection image according to the depth value (step S620). As shown in FIGS. 7A and 7B, when the processor 150 detects that the depth value of the operating object OO changes (i.e., when the operating object OO moves along the depth axis DA as shown in FIGS. 2B and 2C), the processor 150 correspondingly moves the functional operation cursor CU in a longitudinal direction VD (corresponding to the depth axis DA as shown in FIGS. 2B and 2C), so that the functional operation cursor CU aligns with the corresponding function indicator in the function toolbar TB. This method provides intuitive visual feedback of which operation function the user is currently selecting.

The processor 150 may project the projection image through the projector 110 (step S630). Specifically, the processor 150 transmits the generated projection image PIM to the projector 110, and the projector 110 projects the projection image PIM to the display area DK as shown in FIG. 2A.

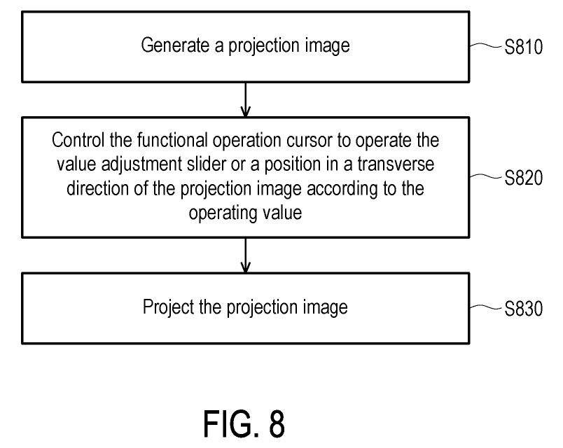

FIG. 8 is a flowchart of a projection image generation method according to an embodiment of the disclosure. Referring to FIG. 8, the processor 150 may generate a projection image (step S810). Specifically, the projection image PIM may include a functional operation cursor, a value adjustment slider, or an operation toolbar. For example, when the selected target function is a volume adjustment function, the processor 150 generates a corresponding value adjustment slider. When the target function is a shortcut key function, the processor 150 generates an operation toolbar. Different positions on the value adjustment slider correspond to different function values. The operation toolbar includes mode indicators respectively corresponding to a plurality of modes (the target mode is one of them).

The processor 150 may control the functional operation cursor to operate the value adjustment slider or a position in a transverse direction of the projection image according to the operating value (step S820). This step converts the detected operating value (e.g., horizontal displacement) into specific visual changes in the projection image. The processor 150 may update the state of the value adjustment slider (e.g., slider position) according to the operating value, or update the transverse position of the functional operation cursor CU on the operation toolbar.

The processor 150 projects the projection image (step S830). Specifically, the processor 150 continuously transmits the generated projection image (in which the position of the functional operation cursor and/or the state of the value adjustment slider may be updated) to the projector 110, and the projector 110 projects the projection image to the display area DK (as shown in FIG. 2A).

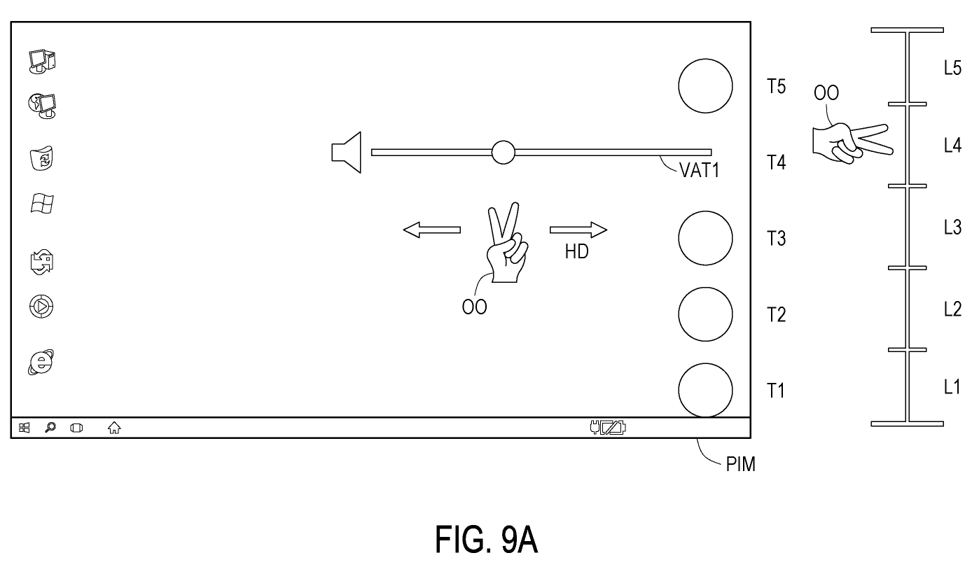

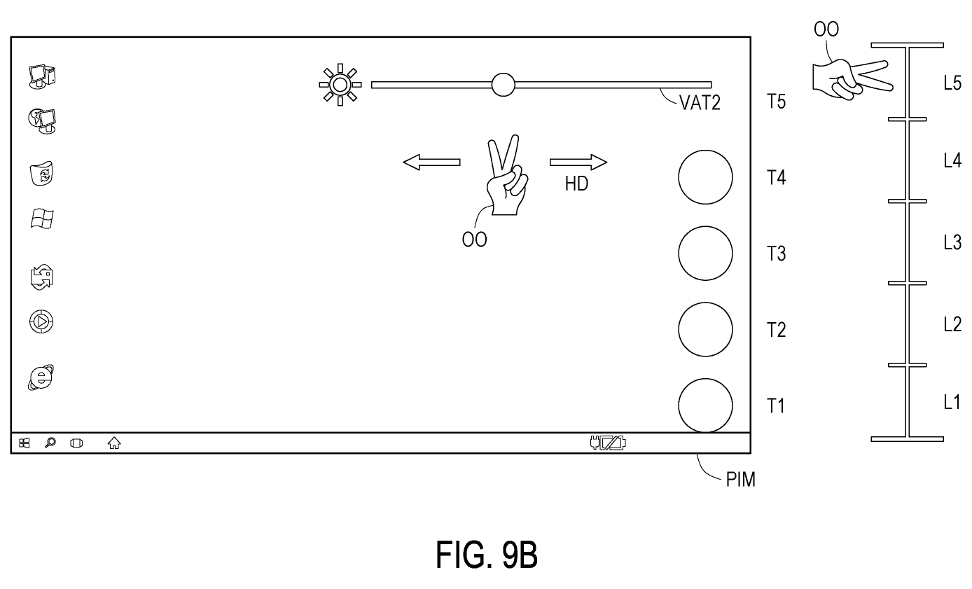

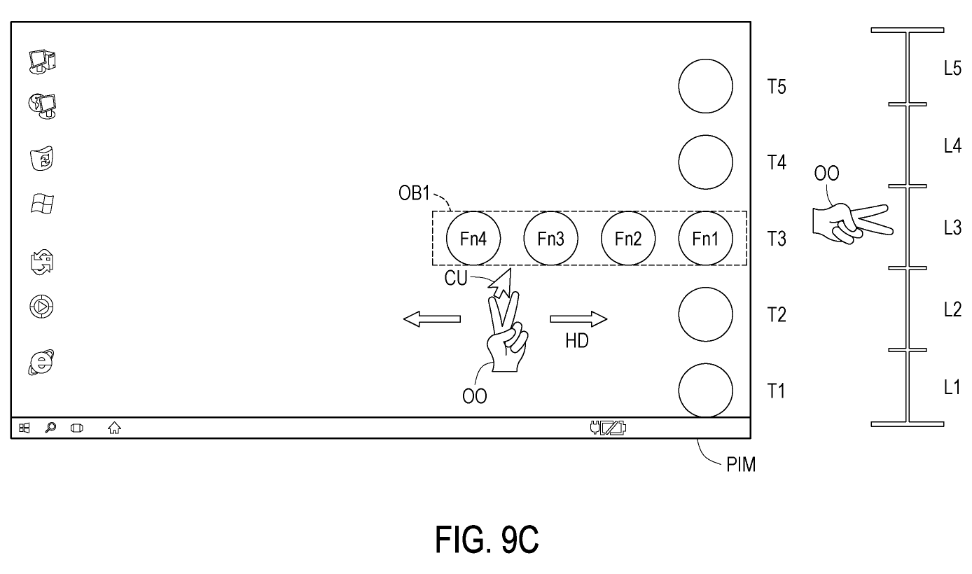

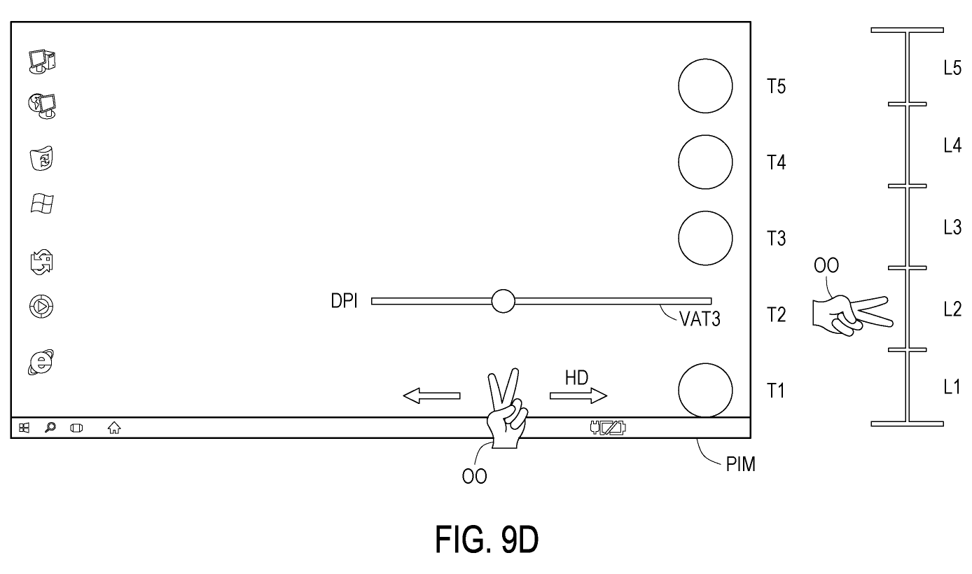

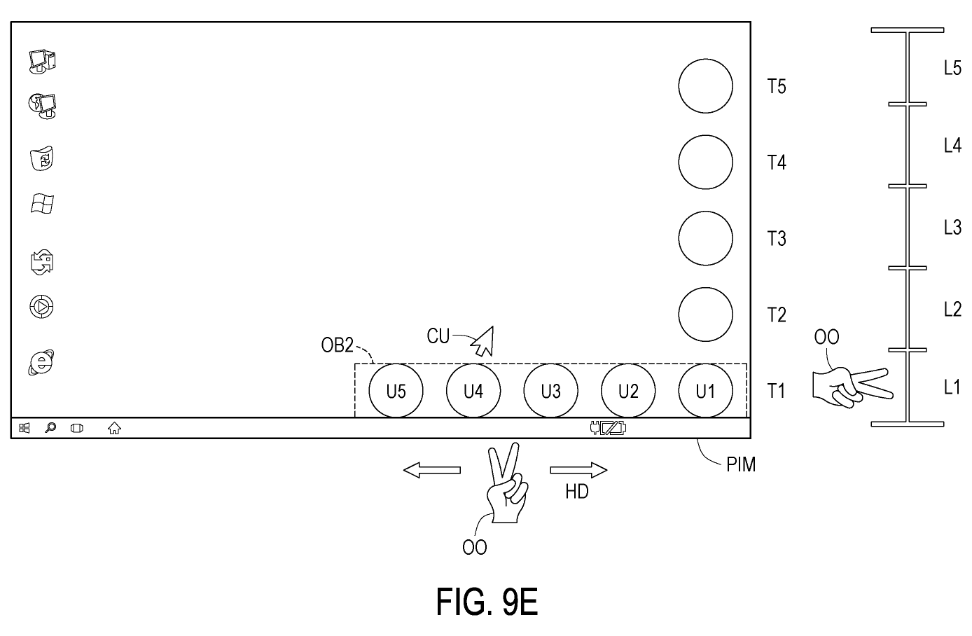

For example, FIGS. 9A to 9E are schematic diagrams of a functional operation interface according to an embodiment of the disclosure. Referring to FIG. 9A, when the target function is the operation function T4 (e.g. the volume adjustment function), the processor 150 may generate the projection image PIM including the value adjustment slider VAT1. When the processor 150 detects that the operating object OO (e.g., a hand) moves along the operating axis (transverse direction HD), the processor 150 correspondingly adjusts the function value (e.g., volume level) on the value adjustment slider VAT1 according to the generated operating value (e.g., horizontal displacement), and projects the updated projection image PIM.

Referring to FIG. 9B, when the target function is the operation function T5(e.g., the brightness adjustment function), the processor 150 may generate the projection image PIM including the value adjustment slider VAT2. The processor 150 adjusts the function value (e.g., brightness level) on the value adjustment slider VAT2 according to the movement of the operating object OO (e.g., a hand) along the transverse direction HD.

Referring to FIG. 9C, when the target function is the operation function T3 (e.g., the shortcut key function), the processor 150 generates the projection image PIM including the operation toolbar OB1, and the operation toolbar OB1 includes indicators of a plurality of shortcut keys Fn1, Fn2, Fn3, Fn4 (e.g., respectively corresponding to copy, paste, select all, and screen-off). The processor 150 controls the position of the functional operation cursor CU in the transverse direction according to the movement of the operating object OO (e.g., a hand) in the transverse direction HD, so as to select a specific shortcut key (e.g., shortcut key Fn2) in the operation toolbar OB1.

Referring to FIG. 9D, when the target function is the operation function T2 (e.g., the cursor sensitivity adjustment function), the processor 150 generates the projection image PIM including the value adjustment slider VAT3. The processor 150 adjusts the function value (e.g., DPI level) according to the movement of the operating object OO (e.g., a hand) in the transverse direction HD. In one application scenario, in an e-sports game, the user may move the operating object OO to the right to increase the DPI (e.g., to 1600) in response to a “street fight” scenario; or move the operating object OO to the left to decrease the DPI (e.g., to 800 or 400) in response to a “sniper” scenario.

Referring to FIG. 9E, when the target function is the operation function T1 (e.g., the mode apply function), the processor 150 generates the projection image PIM including the operation toolbar OB2. The operation toolbar OB2 includes mode indicators corresponding to a plurality of modes U1-U5. The processor 150 controls a position of the functional operation cursor CU in the transverse direction according to the movement of the operating object OO (e.g., a hand) in the transverse direction HD, and accordingly selects a specific mode in the operation toolbar OB2 (e.g., selecting mode U1 (office mode)).

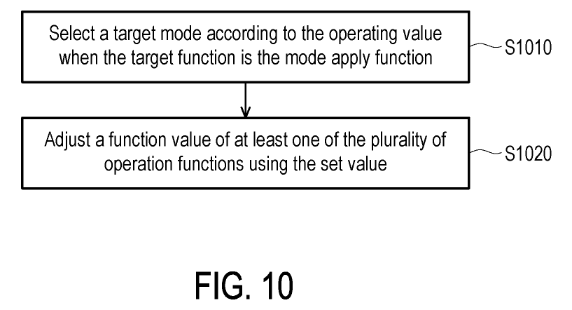

FIG. 10 is a flowchart of a mode apply function according to an embodiment of the disclosure. Referring to FIG. 10, when the target function is the mode apply function, the processor 150 may select a target mode according to the operating value (step S1010). Specifically, as shown in FIG. 9E, the user moves the position of the functional operation cursor CU by moving horizontally along the transverse direction HD (operating value) and selects the target mode (e.g., modes U1 to U5). The target mode includes, for example, mode U1 (office mode), mode U2 (e-sports mode), mode U3 (theater mode), mode U4 (music mode), or mode U5 (drawing mode).

The processor 150 may adjust a function value of at least one of the plurality of operation functions using the set value (step S1020). Specifically, the target mode corresponds to a parameter set, and the parameter set includes at least one set value. The parameter set is a pre-stored configuration file and includes specific settings of a plurality of function values. For example, when the user selects the mode U2 (e.g., the e-sports mode), the processor 150 automatically loads the parameter set of the e-sports mode and immediately adjusts the function values of other operation functions. For example, the brightness (corresponding to the operation function T5) is set to “high”, the volume (corresponding to the operation function T4) is set to “medium-high”, and the cursor sensitivity (corresponding to the operation function T2) is set to “3000 DPI”. That is, the selection of the target mode will cause the function values of one or more operation functions to be correspondingly adjusted.

In an embodiment, the parameter set further includes shortcut key settings corresponding to the shortcut key function. The selection of the target mode will also dynamically change the content of the shortcut key function. For example, when the user selects the mode U1 (e.g., the office mode), the processor 150 sets the content (such as the shortcut keys Fn1-Fn4 in FIG. 9C) of the shortcut key function (corresponding to the operation function T3) to document shortcut keys such as “copy”, “paste”, “save”. However, when the user selects the mode U2 (e.g., the e-sports mode), the processor 150 sets the content of the shortcut key function (corresponding to the operation function T3) to game shortcut keys such as “cast skill 1”, “cast skill 2”, “switch weapon”.

In summary, in the functional operation system and the functional operation method thereof according to the embodiments of the disclosure, the target function is selected by detecting the position of the operating object on the depth axis (first axis), and the function value of the function is adjusted by detecting the movement of the operating object on the operating axis (second axis). The two-dimensional control method of selecting the function on the first axis and adjusting the parameter on the second axis allows the user to quickly and intuitively complete the setting and adjustment of various system functions only by the three-dimensional spatial movement of the hand without interrupting the current operation. In addition, through the mode apply function, one-key switching of multiple function parameters (including shortcut keys) may be achieved, which greatly improves the operation convenience and intuitiveness of human-machine interaction.

Although the disclosure has been described with reference to the embodiments above, the embodiments are not intended to limit the disclosure. Any person skilled in the art can make some changes and modifications without departing from the spirit and scope of the disclosure. Therefore, the scope of the disclosure will be defined in the appended claims.

What is claimed is:

1. A functional operation system, comprising:
a depth sensor, configured to generate a depth image, wherein the depth image comprises an operating object; and
a processor, communicatively connected to the depth sensor, and configured to:
detect a depth of the operating object in the depth image, and generate a depth value corresponding to a depth axis;
select a target function according to the depth value;
detect a movement trajectory of the operating object on an operating axis, and generate a corresponding operating value, wherein the operating axis is perpendicular to the depth axis; and
adjust a function value of the target function according to the operating value.

2. The functional operation system according to claim 1, wherein a plurality of operation functions respectively correspond to a plurality of depth intervals, and the processor is further configured to:
determine that the depth value corresponds to a target interval among the plurality of depth intervals; and
take one of the plurality of operation functions corresponding to the target interval as the target function.

3. The functional operation system according to claim 2, wherein the plurality of operation functions comprise a brightness adjustment function, a volume adjustment function, a cursor sensitivity adjustment function, a shortcut key function, and a mode apply function.

4. The functional operation system according to claim 1, wherein a plurality of operation functions comprise a mode apply function, and the processor is further configured to:
select a target mode according to the operating value when the target function is the mode apply function, wherein the target mode corresponds to a parameter set, and the parameter set comprises at least one set value; and
adjust a function value of at least one of the plurality of operation functions using the at least one set value.

5. The functional operation system according to claim 4, wherein the target mode is an office mode, an e-sports mode, a theater mode, a music mode, or a drawing mode.

6. The functional operation system according to claim 1, further comprising:
a projector, communicatively connected to the processor, wherein the processor is further configured to:
generate a projection image, wherein the projection image comprises a functional operation cursor and a function toolbar corresponding to the depth axis, the function toolbar comprises depth interval indicators or function indicators respectively corresponding to a plurality of operation functions, and the plurality of operation functions comprise the target function;
control a position of the functional operation cursor in a longitudinal direction of the projection image according to the depth value; and
project the projection image through the projector.

7. The functional operation system according to claim 1, further comprising:
a projector, communicatively connected to the processor, wherein the processor is further configured to:
generate a projection image, wherein the projection image comprises a functional operation cursor and a value adjustment slider or an operation toolbar corresponding to the operating axis, different positions on the value adjustment slider correspond to different function values, the operation toolbar comprises mode indicators respectively corresponding to a plurality of modes, and the plurality of modes comprise a target mode;
control the functional operation cursor to operate the value adjustment slider or a position in a transverse direction of the projection image according to the operating value; and
project the projection image through the projector.

8. A functional operation method, comprising:
detecting a depth of an operating object in a depth image, and generating a depth value corresponding to a depth axis;
selecting a target function according to the depth value;
detecting a movement trajectory of the operating object on an operating axis, and generating a corresponding operating value, wherein the operating axis is perpendicular to the depth axis; and
adjusting a function value of the target function according to the operating value.

9. The functional operation method according to claim 8, wherein a plurality of operation functions respectively correspond to a plurality of depth intervals, and selecting the target function according to the depth value comprises:
determining that the depth value corresponds to a target interval among the plurality of depth intervals; and
taking one of the plurality of operation functions corresponding to the target interval as the target function.

10. The functional operation method according to claim 9, wherein the plurality of operation functions comprise a brightness adjustment function, a volume adjustment function, a cursor sensitivity adjustment function, a shortcut key function, and a mode apply function.

11. The functional operation method according to claim 8, wherein a plurality of operation functions comprise a mode apply function, and the functional operation method further comprises:
selecting a target mode according to the operating value when the target function is the mode apply function, wherein the target mode corresponds to a parameter set, and the parameter set comprises at least one set value; and
adjusting a function value of at least one of the plurality of operation functions using the at least one set value.

12. The functional operation method according to claim 11, wherein the target mode is an office mode, an e-sports mode, a theater mode, a music mode, or a drawing mode.

13. The functional operation method according to claim 8, further comprising:
generating a projection image, wherein the projection image comprises a functional operation cursor and a function toolbar corresponding to the depth axis, the function toolbar comprises depth interval indicators or function indicators respectively corresponding to a plurality of operation functions, and the plurality of operation functions comprise the target function;
controlling a position of the functional operation cursor in a longitudinal direction of the projection image according to the depth value; and
projecting the projection image.

14. The functional operation method according to claim 8, further comprising:
generating a projection image, wherein the projection image comprises a functional operation cursor and a value adjustment slider or an operation toolbar corresponding to the operating axis, different positions on the value adjustment slider correspond to different function values, the operation toolbar comprises mode indicators respectively corresponding to a plurality of modes, and the plurality of modes comprise a target mode;
controlling the functional operation cursor to operate the value adjustment slider or a position in a transverse direction of the projection image according to the operating value; and
projecting the projection image.
